(19) United States
(12) Patent Application Publication
(10) Pub. No.: US 2025/0257850 A1
(43) Pub. Date: Aug. 14, 2025

(54) METHOD OF PRODUCING A HYDROGEN TANK, HYDROGEN TANK

(71) Applicant: TOYOTA JIDOSHA KABUSHIKI KAISHA, Toyota-shi Aichi-ken (JP)

(72) Inventors: Osamu SAWAI, Okazaki-shi Aichi-ken (JP); Tomoki NAKASHIMA, Nagoya-shi Aichi-ken (JP); Yuki KAI, Nagoya-shi Aichi-ken (JP); Masato YATSUKURA, Fuji-shi Shizuoka-ken (JP); Kohei KOYAMA, Odawara-shi Kanagawa-ken (JP); Yuki MATSUZAWA, Nerima-ku Tokyo-to (JP); Noriyoshi ASAHINA, Shizuoka-shi Shizuoka-ken (JP)

(73) Assignee: TOYOTA JIDOSHA KABUSHIKI KAISHA, Toyota-shi Aichi-ken (JP)

(21) Appl. No.: 19/033,653

(22) Filed: Jan. 22, 2025

(30) Foreign Application Priority Data
Feb. 8, 2024 (JP) 2024-017727

(51) Int. Cl. F17C 13/00

(52) U.S. Cl. CPC F17C 13/00; F17C 2205/0311; F17C 2209/2154; F17C 2221/012

(57) ABSTRACT

The hydrogen tank is manufactured more easily. The cap is formed by connecting the first cap structure and the second cap structure arranged in the circumferential direction, the first cap structure projections, the second cap structure has a recess, projections are deformed It is pushed into the recess.

### CROSS-REFERENCE TO RELATED APPLICATIONS

This application is based upon and claims the benefit of priority of the prior Japanese Patent Application No. 2024-017727, filed on Feb. 8, 2024, the entire contents of which are incorporated herein by reference.

### TECHNICAL FIELD

The present disclosure relates to a method of manufacturing a hydrogen tank and a hydrogen tank.

### BACKGROUND

In Patent Document 1, in a mouthpiece mounting step (S24) of manufacturing a high pressure container, a mouthpiece 20 is attached to an outer peripheral surface of an opening end portion 14 by fixing a plurality of mouthpiece structures 22 to each other, and in a resin impregnation molding step (S26), a resin is impregnated into a fiber layer while flowing a resin in a groove 36 serving as a resin flow path provided at a contact point with a fiber layer of a plurality of mouthpiece structures 22 Here rivets and bolts are cited as means for connecting a plurality of mouthpiece configurations.

### CITATION LIST

### Patent Literature

Patent Document 1: JP 2023-27912 A

### SUMMARY

### Technical Problem

When using rivets or bolts as a measure for securing a plurality of die structures to each other, the process increases because it requires a hole processing or the like after molding of the die.

In view of the above problems, the present disclosure provides a method of manufacturing a hydrogen tank which can be more easily manufactured. It also provides its hydrogen tank.

### Solution to Problem

The present application discloses a method of manufacturing a hydrogen tank having a mouthpiece, wherein a fiber winding step of winding a fiber around a liner, and a mouthpiece attaching step of attaching a mouthpiece to a liner wrapped with the fiber are provided. The mouthpiece is formed by connecting a first mouthpiece structure and a second mouthpiece structure arranged in a circumferential direction, wherein the first mouthpiece structure has a protrusion and the second mouthpiece structure has a concave portion, and in the mouthpiece attaching step, the protrusion is deformed and pushed into the concave portion to be connected.

Further, the present application discloses a hydrogen tank having a liner, a reinforcing layer disposed on an inner periphery of the liner, and a mouthpiece disposed on an outer periphery of the reinforcing layer, wherein the mouthpiece is formed by connecting a first mouthpiece structure and a second mouthpiece structure disposed in a circumferential direction, wherein the first mouthpiece structure has a protrusion, and the second mouthpiece structure has a recess, and the protrusion is connected by being disposed inside the recess.

### Effects

According to the present disclosure, when a plurality of cap members fixed to each other to a single cap, it is only necessary to deform a part of the cap member, it is not necessary to perform hole machining, it is possible to more easily produce a hydrogen tank.

### BRIEF DESCRIPTION OF DRAWINGS

FIG. 1 is an external view of the hydrogen tank 10.

FIG. 2 is a diagram showing a portion of a cross section of the hydrogen tank 10.

FIG. 3 is a cross-sectional view taken along the line A-A of FIG. 2.

FIG. 4 is an exploded cross-sectional view of the base 30.

FIG. 5 is a cross-sectional view illustrating the attachment of the base 30.

### DESCRIPTION OF EMBODIMENTS

An example of an embodiment according to the present disclosure will be described below with reference to the accompanying drawings.

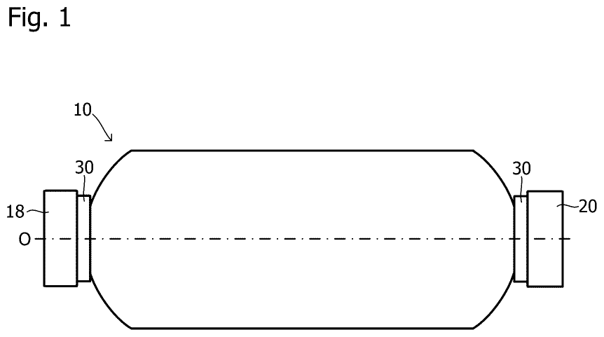

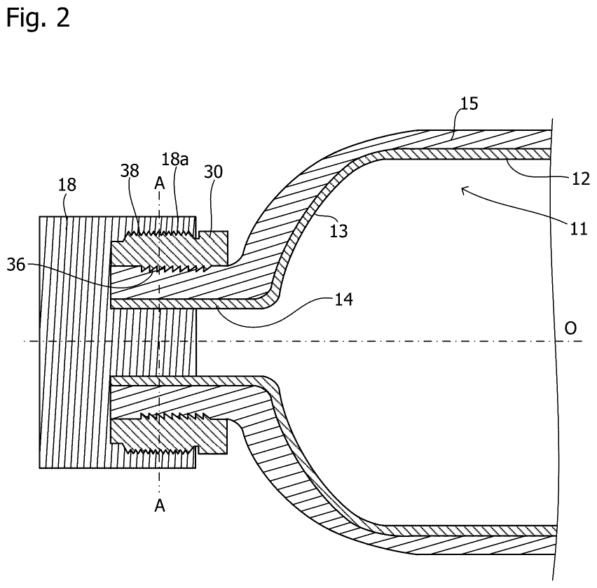

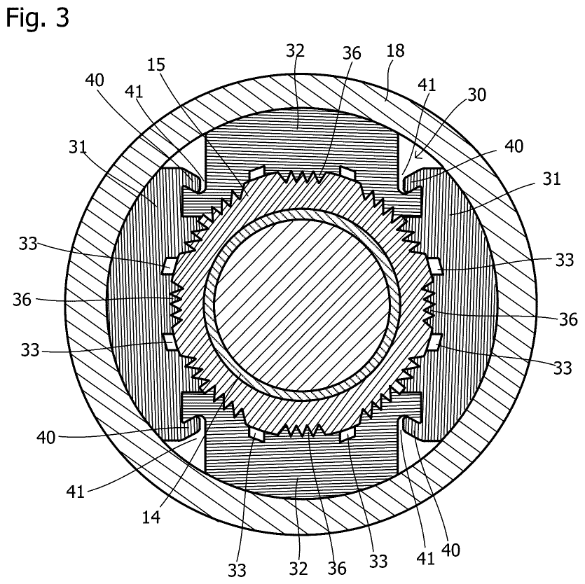

FIG. 1 shows an external view of a hydrogen tank 10 according to one embodiment produced by the hydrogen tank manufacturing method of the present disclosure. Further, FIG. 2 is a cross-section along the axis O of the hydrogen tank 10, the side where the sealing member 18 is disposed (left side of the paper surface of FIG. 1). FIG. 3 is an end view taken along A-A of FIG. 2.

### 1. Configuration of Hydrogen Tank

The hydrogen tank 10 is a member for holding hydrogen to be stored inside thereof. The hydrogen tank is provided, for example, in a hydrogen consuming device comprising a fuel cell, to provide hydrogen as a fuel to the fuel cell for power generation. As can be seen from FIG. 2, the hydrogen tank 10 includes a liner 11 as a container body in which hydrogen is stored, a reinforcing layer 15 for reinforcing by covering the outer surface of the liner 11, and a mouthpiece 30 disposed at both axial ends.

### 1.1. Liner

The liner 11 is a container-like member formed into a substantially cylindrical shape using a resin material such as a polyamide synthetic resin. Specifically, the liner 11 has a body portion 12, a shoulder portion 13, and an open end portion 14.

The body portion 12 is a cylindrical portion in which the inner diameter and outer diameter are constant in the central portion in the direction of the axis O.

The shoulder portion 13 constitutes both side portions of the body portion 12 in the direction of the axis O, and is a dome-like portion which is separated from the body portion 12 and narrows so as to decrease in diameter.

Open end portion 14, from the end opposite the body portion 12 side of the shoulder portion 13, is a cylindrical portion extending in a direction away from the body portion 12 along the axis O. The open end portion 14 has a smaller inner diameter and outer diameter than the body portion 12 and the shoulder portion 13, and is made constant.

### 1.2. Reinforcement Layer

The reinforcing layer 15 is made of fiber-reinforced resin, and the fiber bundle is wound over a plurality of layers over the entire outer surface of the liner 11. Further, in the reinforcing layer 15, a resin is impregnated into the layer of the wound fiber bundle.

The thickness of the reinforcing layer 15 in this form has a configuration that becomes thicker toward the open end portion 14 side from the body portion 12 side of the liner 11 as can be seen from FIG. 2. Furthermore, the reinforcing layer 15 disposed on the open end portion 14 of the liner 11 has its outer diameter as substantially constant. In this form, a carbon-fiber-reinforced resin (CFRP) is used as an exemplary fiber-reinforced resin (FRP).

### 1.3. Mouthpiece

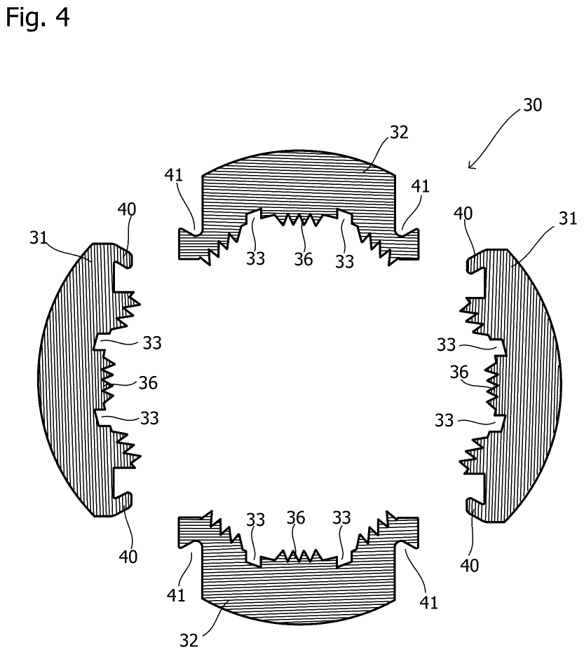

A mouthpiece 30 is disposed on the outer periphery of the reinforcing layer 15 that covers the open end portion 14 of the liner 11. As can be seen from FIG. 3, the mouthpiece 30 in the present embodiment is formed of a metal formed in a cylindrical shape (annular). FIG. 4 shows only the mouthpiece 30 in FIG. 3 represented by disassembling the mouthpiece 30 together with the indication.

In this form, the mouthpiece 30 has a first mouthpiece member 31 and a second mouthpiece member 32 arranged in the circumferential direction. In this form has two first mouthpiece members 31 and two second mouthpiece member 32, the first mouthpiece member 31 and the second mouthpiece member 32 are alternately arranged in the circumferential direction. Since the first mouthpiece member 31 and the second mouthpiece member 32 are combined to form a cylindrical (annular), the first mouthpiece member 31 and the second mouthpiece member 32 are a curved arcuate member.

As shown in FIGS. 2 to 4, the first mouthpiece member 31, the inner peripheral surface of the second mouthpiece member 32 (inner surface), the locking claw 36 is a plurality of projections are formed. The locking claw 36, the inner peripheral surface of the first mouthpiece member 31 and the second mouthpiece member 32 is knurled shape. Each locking claw 36, the tip of the protruding direction in a cross-sectional view cut along the direction and the radial direction of the axis O (radial direction inside) is formed in a pointed saw blade shape. The tip of the locking claw 36, by biting into the outer peripheral portion of the reinforcing layer 15 covering the outer peripheral surface of the opening end portion 14 (locking), the mouthpiece 30 is firmly held (non-rotatably) to the reinforcing layer 15 formed on the outer periphery of the opening end portion 14.

As shown in FIG. 2, the outer peripheral surface of the first mouthpiece member 31 and the second mouthpiece member 32 (outer surface), a male screw groove 38 is formed (FIG. 3, in FIG. 4 male screw groove 38 is omitted). The male screw groove 38 is combined with the female screw groove 18a formed on the inner surface of the sealing member 18.

Further, FIG. 3, as can be seen from FIG. 4, at the circumferential end of the first mouthpiece member 31, the protrusion 40 is disposed at the site to be coupled with the second mouthpiece member 32. Similarly, at the circumferential end of the second mouthpiece member 32, a recess 41 is disposed at the site to be coupled with the first mouthpiece member 31.

Then, the projection 40 by the adjacent first mouthpiece member 31 and the second mouthpiece member 32 is connected by entering the recess 41.

According to such a connecting structure, with rivets and bolts or the like is not required, since it is not necessary to form a hole for that, it is possible to simplify the structure and steps.

Further, the first mouthpiece member 31 and the second mouthpiece member 32, as shown in FIG. 4, the inner peripheral surface of the mouthpiece 30 (inner surface), a plurality of grooves 33 serving as a resin flow path in the manufacturing process described later is formed.

More specifically, the groove 33 is a groove extending in a direction parallel to the axis O in the inner peripheral surface of the mouthpiece 30 (inner surface), from one end in the axial direction O of the mouthpiece 30 to the other end is formed in a straight line. Thus a plurality of grooves 33 are arranged at predetermined intervals in the circumferential direction of the mouthpiece 30. Although there is no particular limitation on the number of grooves 33, at least one, or two, is provided in each of the first mouthpiece member 31 and the second mouthpiece member 32.

### 1.4. Sealing Member, Opening and Closing Valve

The sealing member 18 is attached to the base 30. Thus, the open end 14 on one side of the liner 11 is closed by the sealing member 18.

On the other hand, the other side of the open end of the liner 11 in which the mouthpiece 30 is on, the opening and closing valve 20 is disposed, the hydrogen tank 10 via the on-off valve 20 is connectable to the pipe.

### 2. Method of Manufacturing a Hydrogen Tank

Next, a method of manufacturing a hydrogen tank according to one form of the method of manufacturing a hydrogen tank of the present disclosure will be described. In particular the process of attaching the mouthpiece 30 to the open end portion 14 of the liner 11.

A method for producing a hydrogen tank according to the present embodiment is a method for producing a hydrogen tank 10 by a RTM (Resin Transfer Molding, resin pouring) molding method, and includes a liner forming step (S21), a fiber winding step (S22), a mouthpiece placing step (S23), a mouthpiece attaching step (S24), a sealing member attaching step (S25), a resin impregnating molding step (S26), and a CFRP forming step (S27) as a step.

In the liner forming step (S21), the liner 11 described above is formed. The formation of the liner 11 is not particularly limited, and examples thereof include making a body portion 12 by extrusion molding, making a shoulder portion 13 and an open end portion 14 by injection molding, and joining (welding) the body portion 12 and the shoulder portion 13.

In the fiber winding step (S22), a band-shaped fiber bundle is wound around an outer surface of the liner 11.

Examples of the fibers constituting the fiber bundle include carbon fibers (CF). By winding the fiber bundle around the liner 11, a layer of the fiber bundle is formed on the outer surface of the liner 11. Incidentally, at this time, the fiber bundle is wound so that the layer of the fiber bundle at the open end portion 14 is thicker than that of the body portion 12 and the shoulder portion 13.

In the mouthpiece arrangement step (S23), placing the mouthpiece 30 on the outer peripheral side of the open end portion 14 of the liner 11 (the outer peripheral side of the layer by the fiber bundle). That is, placing the first mouthpiece member 31 and the second mouthpiece member 32 in the circumferential direction of the open end 14. Thus, the tips of the plurality of locking claws 36 provided in the first mouthpiece member 31 and the second mouthpiece member 32 are arranged so as to contact the layer by the fiber bundle.

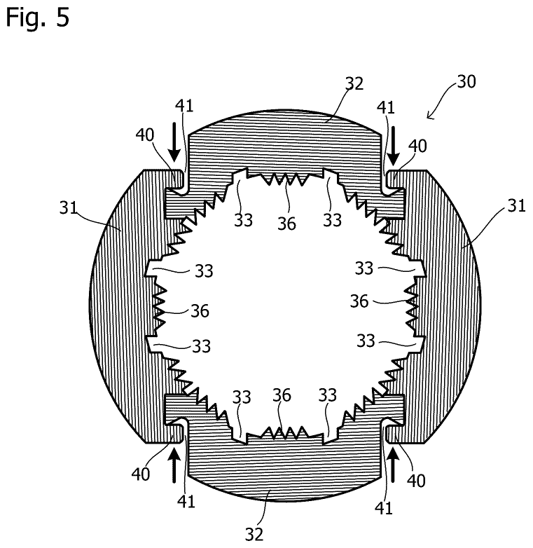

Incidentally, at the time of this step, as shown in FIG. 5, the first mouthpiece member 31 and the second mouthpiece member 32 is combined to circular, but at this time the protrusion 40 of the first mouthpiece member 31 does not enter the inside of the recess 41 of the second mouthpiece member 32 is not connected.

In the cap mounting step (S24), the first mouthpiece member 31 and the second mouthpiece member 32 is reduced in diameter so as to press the layers by the fiber bundle. That is, the first mouthpiece member 31 and the second mouthpiece member 32 is moved radially inwardly, holding against the outer peripheral portion of the layer by the fiber bundle a plurality of locking claws 36 of the inner peripheral surface thereof. Thus, the locking claw 36 is locked to the layer by the fiber bundle.

Then, deformed by pressing the protrusion 40 toward the recess 41 as shown by a straight arrow in FIG. 5 (caulking). Thus, the protrusion 40 as shown in FIG. 3 enters the inside of the recess 41, the first mouthpiece member 31 and the second mouthpiece member 32 is connected.

In the sealing member attaching step (S25), the sealing member 18 is attached to the mouthpiece 30. When the mouthpiece 30 is attached to the open end 14, since the male screw groove 38 is formed on the outer peripheral portion of the first mouthpiece member 31 and the second mouthpiece member 32, the internal thread formed on the inner surface of the sealing member 18 to this by screwing, it is possible to attach the sealing member 18 to the open end portion 14 of the liner 11.

In the resin impregnation molding step (S26), a liner 11 having a mouthpiece 30 and a sealing member 18 attached to an open end portion 14 is set in a mold, and a reinforcing layer 15 made of a fiber-reinforced resin is molded by impregnating a layer of a fiber bundle with a resin by injecting a resin into the mold.

In this embodiment, in the resin impregnation and molding step (S26), the resin (matrix resin) flows into the layer of the fiber bundle through the groove 33, and the resin from the inlet side of RTM mold to the opposite side can be smoothly and substantially uniformly impregnated, and the plurality of locking claws 36 are locked to the reinforcing layer 15.

In CFRP step (S27), by removing the liner 11 to which the reinforcing layers 15 are formed from the mold (releasing), the hydrogen tank 10 is manufactured.

According to the method of manufacturing a hydrogen tank of the present embodiment, the connection of the first mouthpiece member 31 and the second mouthpiece member 32 as described above, since it is performed by pushing the inside of the protrusion 40 in the recess 41, rivets and bolts or the like becomes unnecessary, since it is not necessary to form a hole for that, it is possible to simplify the process.

### REFERENCE SIGNS LIST

10 . . . Hydrogen tank, 11 . . . liner, 14 . . . open end portion, 15 . . . reinforcing layer, 18 . . . sealing member, 30 . . . mouthpiece, 31 . . . first mouthpiece member, 32 . . . second mouthpiece member, 36 . . . locking claw, 40 . . . projection, 41 . . . recess

What is claimed is:

1. A method of manufacturing a hydrogen tank having a mouthpiece, the method comprising:
winding a fiber around a liner; and
attaching a mouthpiece to the liner around which the fiber is wound, wherein
the mouthpiece is formed by coupling at least one first mouthpiece component and at least one second mouthpiece component to each other, the first and second mouthpiece components being arranged in a circumferential direction, the first mouthpiece component having projections, the second mouthpiece component having depressions, and
in said attaching, shapes of the projections are changed and the projections are pushed into the depressions whereby the first and second mouthpiece components are coupled to each other.

2. A hydrogen tank comprising:
a liner;
a reinforcing layer disposed around a periphery of the liner; and
a mouthpiece disposed at a periphery of the reinforcing layer, wherein
the mouthpiece is formed by coupling at least one first mouthpiece component and at least one second mouthpiece component to each other, the first and second mouthpiece components being arranged in a circumferential direction, the first mouthpiece component having projections, the second mouthpiece component having depressions, and
the projections are arranged inside the depressions whereby the first and second mouthpiece components are coupled to each other.
